(19) United States
(12) Patent Application Publication
(10) Pub. No.: US 2026/0057796 A1
(43) Pub. Date: Feb. 26, 2026

(54) Videogame for Math Skills Development

(71) Applicant: Severex PL SP z o.o., Warsaw (PL)

(72) Inventor: Alexey Nikolayevich GORYAYNOV, Minsk (BY)

(73) Assignee: Severex PL SP z o.o., Warsaw (PL)

(21) Appl. No.: 18/988,296

(22) Filed: Dec. 19, 2024

Related U.S. Application Data
(60) Provisional application No. 63/686,389, filed on Aug. 23, 2024.

(51) Int. Cl. G09B 5/06; A63F 13/44; A63F 13/80

(52) U.S. Cl. CPC G09B 5/065; A63F 13/44; A63F 13/80; A63F 2300/8064

(57) ABSTRACT

Methods for executing videogame mechanics include rendering on the display a phrase encrypted with numbers individually corresponding to letters, math equations displayed in cells filled with numbers or question-marked to be filled to solve the equations. Additionally, the videogame offers to the player a preset list of numbers for filling the question-marked cells. When the equations are solved, all the letters, corresponding to the numbers from the equations, substitute the encrypted numbers in the phrase revealing it, which phrase can be related to factual knowledge. For filling the numbers in the question-marked cells, the player uses drag-and-drop technique, or input controllers, e.g. touchpad, virtual keyboard, speech recognition-based command, button-based, etc. The videogame device includes processors for determining correctness of solutions, updating the phrase, and interface mechanism for checking correctness of solutions of the equations. The methods engage players through interconnected equation-solving dynamics providing a unique cognitive challenge and educational experience.

### CROSS REFERENCES TO RELATED APPLICATIONS

The present patent application claims the benefit of a U.S. provisional patent application Ser. No. 63/686,389 filed on Aug. 23, 2024, the disclosure of which is incorporated herein in its entirety by reference.

### FIELD OF THE INVENTION

The invention pertains to videogames (e.g. mobile games) where players reveal a hidden phrase by solving math equations. The invention specifically relates to methods and a system for revealing hidden phrases through the process of solving math equations.

### BACKGROUND OF THE INVENTION

There is known a videogame “Cryptarithms—Number Puzzles and Math Riddles” published on <https://play.google.com/store/apps/details?gl=US&hl=en-US&id=com.anduda.cryptarithm>. It sets two groups of cells on the display, wherein the first group includes a number of cells; one of the cells is filled with a letter, while the other cells each is filled with a digit. This first group represents an equation. There is the second group of cells each filled with a digit; thus the second group represents a predetermined list of digits. The game prompts the player to choose a digit from the second group to substitute the letter in the first group such that the equation would be correctly solved that would be indicated on the display. While the mentioned videogame is useful for beginners, it allows the player to operate with ten digits (from 0 to 9), and cannot be used to present more complicated equations (that require using numbers greater than 9) for solution. It therefore has a limited educational value for more advanced players.

### BRIEF SUMMARY OF THE INVENTION

This invention offers an engaging and educational videogame experience by utilizing a unique number-letter system to reveal hidden phrases progressively. The inventive method enhances a player's engagement through interconnected equation-solving dynamics and the addition of interesting facts, providing a unique cognitive challenge. The additional mechanics of requiring all numbers in the equations to be correctly placed before revealing letters ensures a higher level of difficulty and player satisfaction. The multi-user gaming mechanic adds a competitive and social dimension to the educational and engaging gameplay.

A simplified explanation of the videogame follows. Each letter in a hidden (encrypted) phrase or word corresponds to a unique number. The players solve mathematical equations, and correct solutions reveal letters associated with specific numbers involved in the equations, enabling the players to progressively uncover the hidden phrase. The letters are revealed only when the numbers involved in the equation are correctly placed, ensuring a more challenging and engaging gameplay experience.

In summary, the invention proposes methods for executing videogame mechanics that include: rendering on the display a hidden phrase or word encrypted with numbers individually related to letters associated therewith through an index system, and math equations displayed in cells filled with numbers or specifically marked (e.g. question-marked) cells to be filled by the player in order to solve the equations. Additionally, the videogame offers to the player a preset list of numbers for filling in the specifically marked cells. When the equations are correctly solved, all the letters, corresponding to the numbers from the equations, substitute the encrypted numbers in the hidden phrase thereby revealing it, which phrase can be further related to factual knowledge that can also be separately shown on the display. For filing the numbers into the specifically marked cells, the player can use the drag-and-drop technique, or input controllers, such as touchpad, virtual keyboard, speech recognition-based command, button-based, etc. The videogame can be implemented in a one player mode, or in a multi-player mode. The videogame device preferably includes processors for determining correctness of solutions of the equations, updating the hidden phrase, and an interface mechanism for checking correctness of solutions of the equations. The proposed methods engage players through interconnected equation-solving dynamics providing a unique cognitive challenge and educational experience.

### BRIEF DESCRIPTION OF DRAWINGS OF THE INVENTION

FIGS. 1a and 1b depict a diagram of the game screen for a single-player mode, showing an exemplary schematic representation of the main game mechanics. The elements of the diagram can optionally be situated differently on the display, according to particular design requirements.

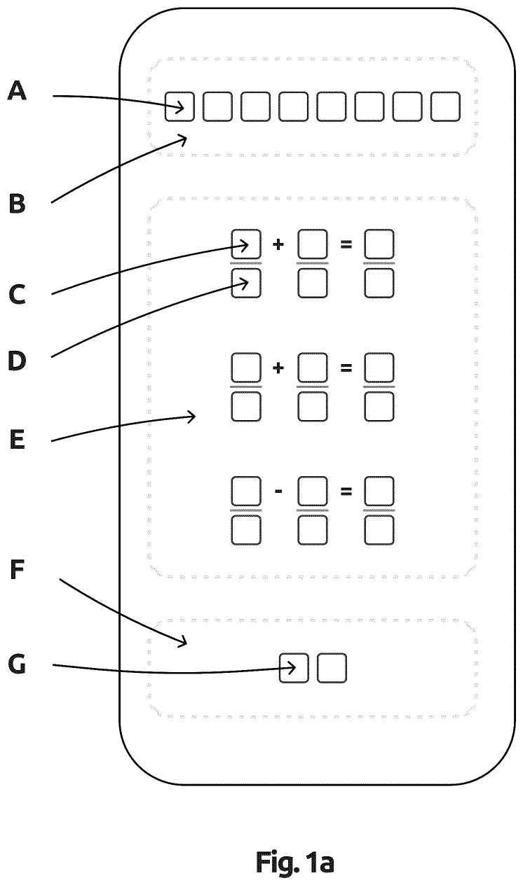

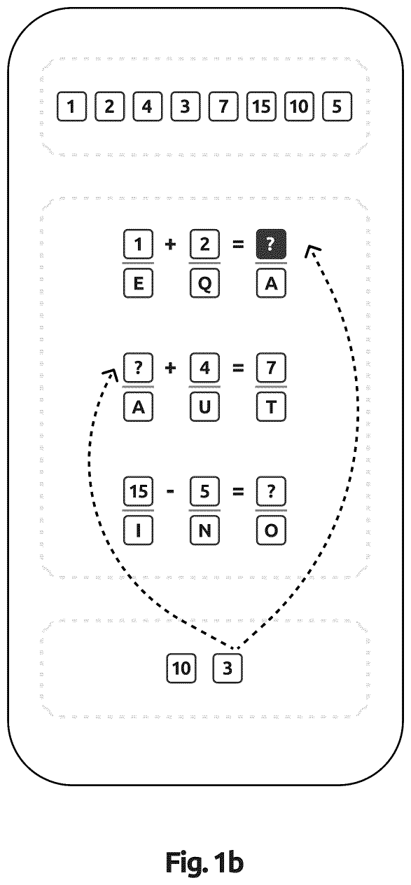

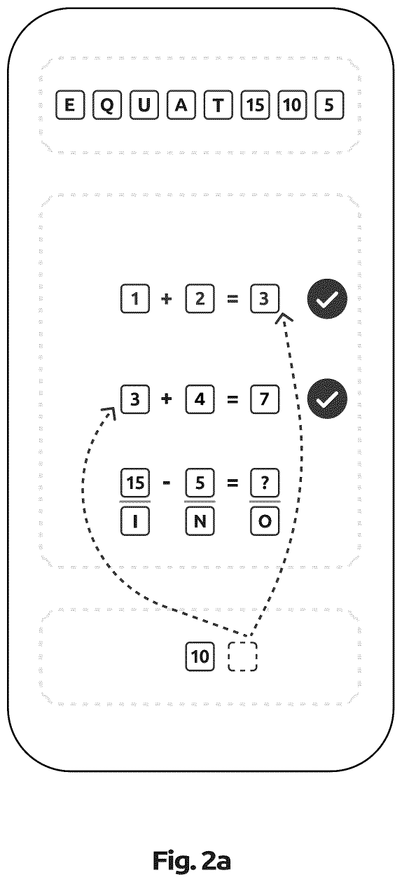

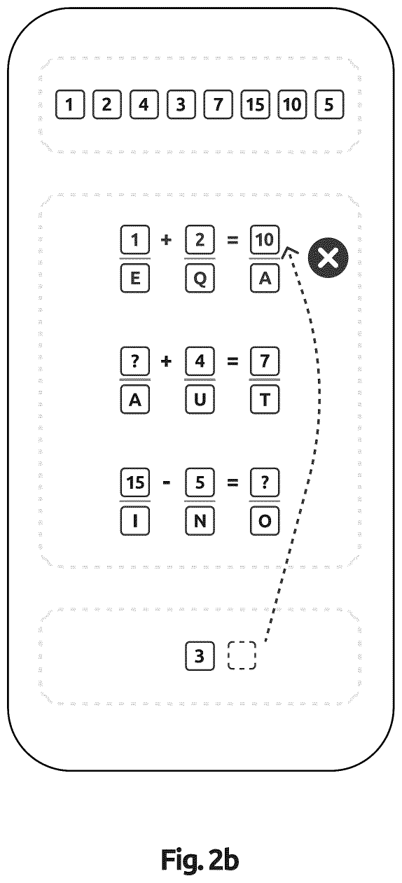

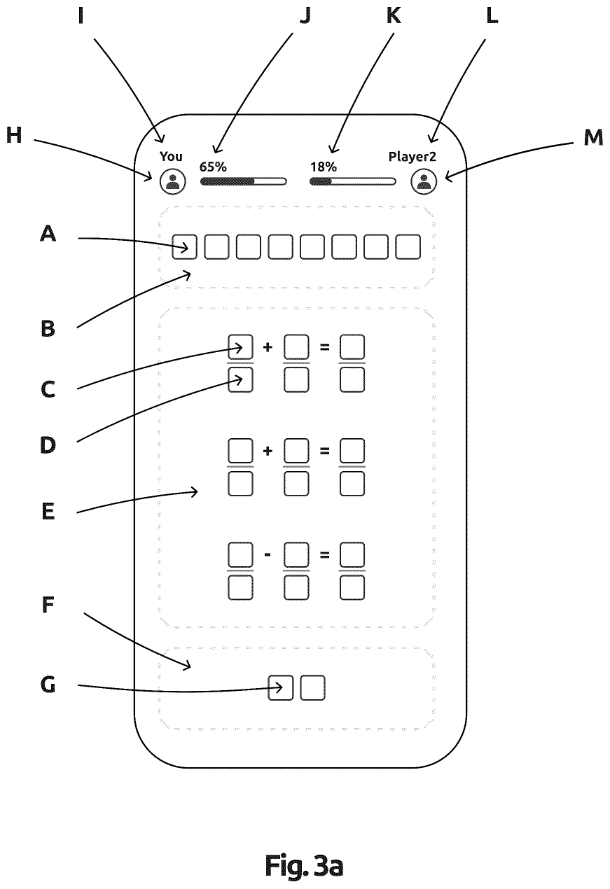

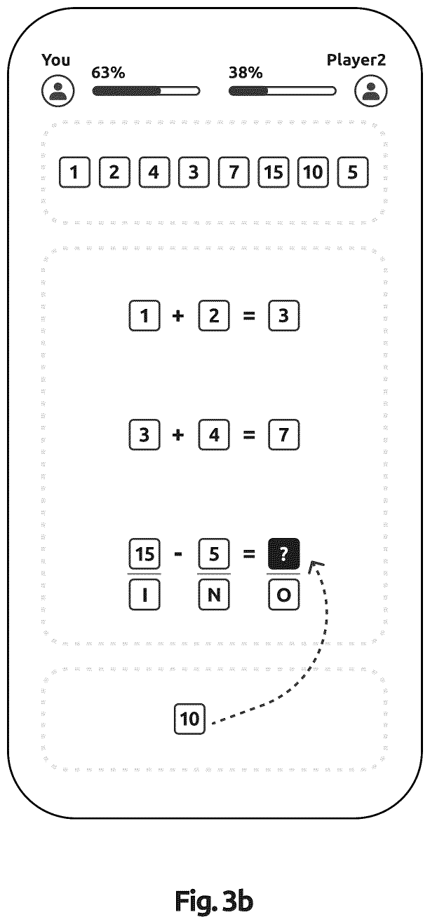

Elements schematically illustrated in the drawings of FIG. 1a (showing a game interface structure for a single player mode of the videogame) follow:
A—Non-editable cells (or blank spaces) of letters from an encrypted phrase;
B—Area where the encrypted phrase is located;
C—Editable cells of numbers that participate in equations;
D—Non-editable cells (or blank spaces) for letters corresponding to the numbers;
E—Area where the equations are displayed;
F—Area where proposed (suggested by the videogame program) numbers are displayed that can be used to solve the equations;
G—Cells filled with proposed numbers are displayed that can be selected for substitution into the equations;

Elements schematically illustrated in the drawings of FIG. 1b (showing a game example for a particular encrypted phrase to be revealed by the player by solving corresponding equations) follow:
A—Non-editable cells (or blank spaces), also shown in FIG. 1a, for letters from an encrypted phrase;
B—Area, also shown in FIG. 1a, where the encrypted phrase is located; Area B contains the A cells;
C—Editable cells (or blank spaces), also shown in FIG. 1a, for numbers that participate in the first, second and third equations;
D—Non-editable cells (or blank spaces), also shown in FIG. 1a, for letters corresponding to the numbers of the first, second and third equations shown in the C cells; the letters are placed programmatically into the D cells. All these letters can be automatically moved to the A cells, only after the player correctly solves a single equation (if only one equation is presented to the player), or a group of connected equations (if such group of equations is presented to the player). Equations are considered to be connected, if they contain cells with the same letters.
E—Area, also shown in FIG. 1a, where the first, second and third equations are displayed.
F—Area, also shown in FIG. 1a, wherein suggested numbers that can be used to solve the first, second and third equations are located;
G—Cells, within the F area, programmatically filled with suggested numbers that can be selected for substitution (i.e. entering them by the player) in the C cells (preferably marked with a ‘?’ symbol) of the first, second and third equations.

FIGS. 2a and 2b illustrate a diagram of the game screen for a single-player mode showing the hidden phrase and corresponding numbers, correct and incorrect solutions of the equations, and suggested numbers.

FIGS. 3a and 3b illustrate a diagram of the game screen for a multiplayer mode, showing a schematic representation of main elements of the multiplayer mode. The game mechanics and elements are identical to those in the single-player mode described above.

Elements of drawing on FIG. 3a (showing a game interface structure for a multiple player mode of the videogame, in this case for two players) follow:
A—Non-editable cells (or blank spaces) for letters from an encrypted phrase;
B—Area where the encrypted phrase is located;
C—Editable cells, located in the B area for numbers that participate in mathematical equations
D—Non-editable cells (or blank spaces) for letters corresponding to the numbers shown in the C cells;
E—Area where the equations are displayed;
F—Area where numbers that can be used to solve the equations are located;
G—Cells programmatically filled with numbers that can be selected for substitution into the equations;
H—Image of the current player's profile
I—Name of the current player's profile
J—Display of the current player's game progress
K—Display of the opponent's game progress
L—Name of the opponent's profile
M—Image of the opponent's profile

The diagram on FIG. 3b shows an example of the videogame's episode in the multiple player mode.

### DETAILED DESCRIPTION OF PREFERRED EMBODIMENTS OF THE INVENTION

### Game Setup

The videogame generates a hidden (encrypted) phrase or word, consisting of letters displayed in cells, wherein each such cell may contain one letter, or remain blank. The hidden (encrypted) phrase is presented to the player on the display.
Each unique letter in the hidden phrase is assigned a unique number through an index system.

### Equation Mechanism

A series of math equations are presented to the player.
The equations can be presented via text or other visual methods.
An equation or a group of related equations, when solved correctly, reveals one or more letters associated with the numbers involved in the solved equations.

### Mechanics of Solving Math Equations

Each equation involves several numbers corresponding to different letters in the hidden phrase.
The players must place all the numbers programmatically preset in the G cells in the correct positions of the corresponding C cells within the equations.
The letters associated with the numbers will only be revealed in the hidden phrase (in the A cells) if all numbers involved in the equations are placed correctly in the related equations (in the C cells).
   An example is shown in FIG. 1b. When the number 3 is placed in the “?” cell C of the first and second equations, making the equations correct, the letters E, Q, A, U and T will automatically disappear from the D cells and will be automatically transferred to the A cells in the encrypted phrase.
If any number is placed incorrectly, the corresponding letters will not be revealed in the A cells, and the player must adjust their solutions.

### Indexing System

Each letter in the hidden phrase corresponds to a unique number.
When a number is correctly placed and revealed through solving an equation or a group of related equations, the letter (in the corresponding C-cell) substitutes the number in all of the A-cell in the hidden phrase where the corresponding number is present. For example, if the number 3 is associated with the letter ‘A’ (see FIG. 1b), then solving an equation with the number 3 will display the letter ‘A’ in all A-cells initially filled with the number 3 in the hidden phrase.

### User Interface

The game interface displays the hidden phrase with numbered blank spaces or cells.
A separate section presents the equations and input fields (G-cells) for solutions.
Upon solving each of the equations, the correct letters (corresponding to the correct numbers selected by the player from the G-cells and inputted into the question-marked C-cells) appear in the hidden phrase (A-cells) according to their corresponding numbers.
The correct solution of an equation is followed by a positive visual signal (e.g. a check mark, or a plus sign) on the display that can also be used with a corresponding positive sound. On the other hand, the incorrect solution of an equation is followed by a negative visual signal (e.g. an X mark, or a minus sign) on the display that can also be used with a corresponding negative sound.

### Input Methods

Numbers for the equations can be chosen from a predefined list of pre-programed suggested numbers used on the level, either by a drag-and-drop action of the number into the C-cells by the player or entered the number via the keyboard by the player directly into the C-cells.
Alternatively, other known methods of input can be provided e.g. touchpad input, virtual keyboard input, speech recognition-based command input external controllers, button-based input, etc.

### Educational Element

Equations shown to the player can be presented with different levels of complication, e.g. the second equation can be more difficult for finding the solution than the first equation, etc.
After the level is finished, a fact related to the hidden phrase is presented to the player.
The hidden phrase is derived from this fact adds an educational element to the game. For instance, the hidden phrase may represent a fragment of text describing an educational fact. For example, the phrase “turn into ice faster” may correspond to the fact “hot water will turn into ice faster than cold water”.
When the player inputs a number from a group of numbers preset in the G cells into a C cell related with a corresponding D cell (displayed below the C cell) in a first equation, then he/she can consider finding another D cell with the same letter in a second equation. When the same letter in the corresponding D cell of the second equation is found, then, if the number fits into the second equation (that gets it correctly solved), the player would insert the number in the corresponding C cells of the first equation and the second equation; if both of the equations are solved then the corresponding letter disappears from the D cells and appears in the corresponding A cells of the hidden phrase. However, if the number does not apparently fit to the second equation, the player might decide not to input it into the first equation (that is changing his/her mind) and chose another number for inputting it into the first equation and the second equation. Through such interconnected equation-solving dynamics, this technique provides a unique cognitive challenge, stimulates developing math skills (i.e. skills for solution of math equations) of the player, and adds an educational value to the inventive method.

### Game Play for a Single-User Mode

The player solves the equations in any order he/she chooses.
Answers are checked automatically by the videogame program.
Correct letters can be rendered in the hidden phrase automatically after at least one of the equations is solved correctly. The game continues until the entire hidden phrase is revealed or the player decides to quit.

### Introduction to Multi-User Mode

The multi-user mode extends the single-player experience to a competitive format, allowing at least two players to engage in the same game level simultaneously. In this mode, the players compete to solve the math equations and reveal the hidden phrase faster than their opponent.

### Game Play for a Multi-User (Two-User) Mode

The core gameplay remains the same, but includes turn-based or real-time play: the multi-user mode can be configured for turn-based play, where players take turns solving equations (in a turn-based sequence), or real-time play, where both players solve equations simultaneously (on a real-time basis);
Both players are presented with the same set of equations and the same hidden phrase;
Players receive real-time feedback on their opponent's progress. This may include how many letters in the phrase have been revealed and which equations have been solved;
The game interface is adapted to display real-time progress for both players, highlighting who has uncovered more of the hidden phrase;
A timer (meter) may be present to limit the duration of each game, adding a time-based pressure element to the competition;
The winner is determined either by who reveals the entire hidden phrase first or who has revealed the most letters by the end of the game.

### A Method for Executing Visual Mechanics of the Videogame in a One Player Mode

According to one preferred embodiment of the invention, there is proposed a method for executing visual mechanics of videogame in a one player mode, wherein the visual mechanics are carried out by a videogame device including at least a display and a number of input controllers, wherein the videogame device is preprogrammed with an indexing system and a videogame program, including a game interface that renders elements of the videogame on the display;
wherein the method comprises the steps of:
   rendering on the display an area B that contains a number of non-editable cells A each initially filled with an initial number or left blank; wherein the cells A collectively represent an encrypted phrase or word;
   rendering on the display an E area;
   rendering on the display a plurality of editable cells C arranged in a number of rows located in the E area; wherein the rows each represents one of mathematical equations, some of the cells C are filled with numbers preset by the videogame program, whereas the other cells C remain marked and are to be filled with numbers provided by a player of the videogame, using the input controllers, such that a corresponding mathematical equation can be solved, and wherein any number in the cells C corresponds to a unique letter in accordance with the indexing system;
   rendering on the display a plurality of non-editable cells D located in the E area; wherein the cells D each is initially filled with the corresponding unique letter, according to the numbers preset by the videogame program with the use of the indexing system;
   rendering on the display an F area;
   rendering on the display a plurality of cells G located in the F area, wherein the cells G contain suggested numbers produced by the videogame program and are offered to the player to be filled in said marked cells C from said plurality of editable cells C;
   placing by the player, using the input controllers, the suggested numbers from the cells G into the marked cells C thereby filling in all the cells C with numbers in an attempt to solve the mathematical equations rendered in the E area;
   evaluating by the videogame program whether each of the corresponding mathematical equation is correctly solved; and
   if all of the mathematical equations are correctly solved, indicating a positive signal, and rendering by the videogame program on the display the letters from the cells D, corresponding to the cells C of the correctly solved equation, into the respective cells A, thereby entirely displaying the encrypted phrase or word, while discontinuing displaying the cells D of the correctly solved equations; or
   if any of the mathematical equations is incorrectly solved, continuing displaying the cells D of the incorrectly solved equation and indicating a negative signal, while the cells A of the incorrectly solved equation remain filled with the initial numbers, and thereby not displaying the encrypted phrase or word.

As mentioned hereinabove, the player is presented with mathematical equations of different levels of complication. Therefore, such a predefined list of numbers can be different depending on the level of complication.

Additionally, the videogame device of the Method for one-player mode includes:
a processor for determining correctness of solutions of the mathematical equations;
a processor for updating the encrypted phrase or word with letters according to the corresponding numbers provided by the user; and
an interface mechanism for automatically checking correctness of solutions of the mathematical equations.

### A Method for Executing Visual Mechanics of the Videogame in a Multi-Player Mode

According to another preferred embodiment of the invention, there is proposed a method for executing visual mechanics of videogame in an multi-player mode, wherein the videogame is played by at least two players, the visual mechanics are carried out by at least two videogame devices each including at least a display and a number of input controllers, wherein the at least two videogame devices operated by the at least two players; the at least two videogame devices are preprogrammed with a common indexing system and a common videogame program, including a game interface that renders elements of the videogame on displays of all of the at least two videogame devices;
wherein the method comprises the steps of:
   rendering on each of the displays an area B that contains a number of non-editable cells A each initially filled with an initial number or left blank; wherein the cells A collectively represent an encrypted phrase or word;
   rendering on each of the displays an E area;
   rendering on each of the displays a plurality of editable cells C arranged in a number of rows located in the E area; wherein the rows each represents one of mathematical equations, some of the cells C are filled with numbers preset by the videogame program, whereas the other cells C remain marked (e.g. question-marked, or marked with another symbol) and are to be filled with numbers provided by a player of the videogame, using the input controllers, such that a corresponding mathematical equation can be solved, and wherein any number in the cells C corresponds to a unique letter in accordance with the indexing system;
   rendering on each of the displays a plurality of non-editable cells D located in the E area; wherein the cells D each is initially filled with the corresponding unique letter, according to the numbers preset by the videogame program with the use of the indexing system;
   rendering an F area on each of the displays;
   rendering on each of the displays a plurality of cells G located in the F area, wherein the cells G contain suggested numbers preset by the videogame program and are offered to the player to be filled in said marked cells C from said plurality of editable cells C;
   placing by each of the at least two players either in a turn-based sequence or on a real-time (parallel) basis, using the input controllers, the suggested numbers from the cells G into the marked cells C thereby filling in all the cells C with numbers in an attempt to solve the mathematical equations rendered in the E area;
   evaluating by the videogame program whether each of the corresponding mathematical equation is correctly solved; and
   if the all of the mathematical equations are correctly solved, indicating a positive signal (e.g. a check mark, or a plus sign) next to the correctly solved equations, and rendering by the videogame program on the display the letters from the cells D, corresponding to the cells C of the correctly solved equation, into all of the cells A, thereby entirely displaying the encrypted phrase or word, while discontinuing displaying the letters in the cells D; or
   if any of the mathematical equations is incorrectly solved, continuing displaying the cells D of the incorrectly solved equation and indicating a negative signal (e.g. an X symbol, or a minus sign next to the incorrectly solved equation), while the cells A of the incorrectly solved equation remain filled with the initial numbers, and thereby not displaying the encrypted phrase or word.

Additionally, the videogame device of the Method for multi-player mode may include:
a processor for determining correctness of solutions of the mathematical equations;
a processor for updating the encrypted phrase or word with letters according to the corresponding numbers provided by the user;
an interface mechanism for automatic checking correctness of solutions of the mathematical equations;
an interface mechanism for real-time feedback on their opponent's progress for all of the players, highlighting who has uncovered more of the hidden phrase;
a timer may be rendered on the displays of the players, to limit the duration of each game, adding a time-based pressure element to the competition.

I claim:

1. A method for executing visual mechanics of videogame, said visual mechanics are carried out by a videogame device including at least a display and a number of input controllers, wherein said videogame device is operated by a player, and preprogrammed by a videogame program including a game interface for rendering on the display videogame elements; said videogame program is associated with an indexing system; said method comprising the steps of:
rendering, by the game interface, an area B that contains a number of non-editable cells A each to be filled with a letter or a space between letters; wherein the cells A collectively represent an encrypted phrase or word;
rendering, by the game interface, an E area;
rendering, by the game interface, a plurality of editable cells C arranged in a number of rows located in the E area; wherein said rows each represents a mathematical equation, a first portion of said cells C are filled with numbers preset by the videogame program, whereas a second portion of said cells C remain specifically marked and are to be filled with numbers provided by the player of the videogame, and wherein any said number in the cells C corresponds to a unique letter in accordance with the indexing system;
rendering on the display a plurality of non-editable cells D located in the E area; wherein the cells D are initially filled with the unique letters corresponding to the numbers in the respective cells C of the first portion;
rendering, by the game interface, an F area;
rendering, by the game interface, a plurality of cells G located in the F area, wherein said cells G contain suggested numbers preset by the videogame program and are offered to the player to be filled in the second portion of specifically marked cells C;
using the input controllers, placing, by the player, the suggested numbers from the cells G into the second portion of specifically marked cells C, thereby filling in all of the cells C in an attempt to solve the mathematical equations rendered in the E area;
evaluating by the videogame program whether each of the corresponding mathematical equation is correctly solved; and
if all of the mathematical equations are correctly solved, discontinuing displaying the letters in the cells D, and rendering, by the game interface, the corresponding letters in the corresponding cells A thereby entirely displaying the encrypted phrase or word; or
if any of the mathematical equations is incorrectly solved, continuing displaying the letters in the cells D, and not displaying, by the game interface, the encrypted phrase or word.

2. The method according to claim 1, wherein
said specifically marked cells C each is filled with a question mark;
said number of input controllers are provided by the use of at least one of the following:
touchpad input, virtual keyboard input, speech recognition-based command input, and button-based input; and
if all of the mathematical equations are correctly solved, producing a positive signal by said videogame device; or
if at least one of the mathematical equations is incorrectly solved, producing a negative signal by said videogame device.

3. The method according to claim 1, wherein said videogame device further includes:
a processor for determining correctness of solutions of the mathematical equations;
a processor for updating the encrypted phrase or word with letters according to the corresponding numbers provided by the player; and
an interface mechanism for automatic checking correctness of solutions of the mathematical equations.

4. A method for executing visual mechanics of videogame; said visual mechanics are carried out by at least two videogame devices each including at least a display and a number of input controllers, wherein the at least two videogame devices are operated by at least two players; said at least two videogame devices are preprogrammed with a common indexing system and a common videogame program;
wherein said least two videogame devices each includes a game interface for rendering videogame elements on the corresponding display;
said method comprising the steps of:
rendering, by the corresponding game interface, an area B that contains a number of non-editable cells A each to be filled with a letter or a space between letters; wherein the cells A collectively represent an encrypted phrase or word;
rendering, by the corresponding game interface, an E area;
rendering, by the corresponding game interface, a plurality of editable cells C arranged in a number of rows located in the E area; wherein said rows each represents a mathematical equation, a first portion of said cells C are filled with numbers preset by the videogame program, whereas the a second portion of the cells C remain specifically marked, and are to be filled with numbers provided by the corresponding player, and wherein any said number in the cells C corresponds to a unique letter in accordance with the indexing system;
rendering, by the corresponding game interface, a plurality of non-editable cells D located in the E area; wherein the cells D each is initially filled with said unique letter corresponding to the number in the respective cell C of the first portion;
rendering, by the corresponding game interface, an F area;
rendering, by the corresponding game interface, a plurality of cells G located in the F area, wherein said cells G contain suggested numbers preset by the videogame program and are offered to each of the at least two players;
using the corresponding input controllers, placing the suggested numbers, by the corresponding player, into the second portion of specifically marked cells C, thereby filling in all of the cells C in an attempt to solve the mathematical equations rendered in the E area;
evaluating by the videogame program whether each of the corresponding mathematical equation is correctly solved; and
if all of the mathematical equations are correctly solved, rendering, by the corresponding game interface, the corresponding letters into the cells A thereby displaying the encrypted phrase or word, and discontinuing displaying the corresponding D cells; or
if any of the mathematical equations is incorrectly solved, not displaying, by the corresponding game interface, the encrypted phrase or word, and continuing displaying the corresponding D cells.

5. The method according to claim 4, wherein
said specifically marked cells C each is filled with a question mark;
said number of input controllers are provided by the use of at least one of the following:
touchpad input, virtual keyboard input, speech recognition-based command input, and button-based input; and
if all of the mathematical equations are correctly solved, producing a positive signal by the corresponding videogame device; or
if at least one of the mathematical equations is incorrectly solved, producing a negative signal by the corresponding videogame device.

6. The method according to claim 4, wherein each of said videogame devices includes:
a processor for determining correctness of solutions of the mathematical equations;
a processor for updating the encrypted phrase or word with letters according to the corresponding numbers provided by the player; and
an interface mechanism for automatic checking correctness of solutions of the mathematical equations.

7. The method according to claim 4, wherein said placing the suggested numbers into the second portion of specifically marked cells C is provided by each of the at least two players either in a turn-based sequence or simultaneously on a real-time basis.

8. The method according to claim 4, wherein the corresponding game interface renders on the corresponding display a meter showing how many letters in the hidden phrase or word are revealed by each of the at least two players, and which of the mathematical equations are currently solved by each of the at least two players.

9. The method according to claim 4, wherein the videogame is limited by a time limit, and the corresponding game interface renders on the corresponding display a timer showing a time left to the end of said time limit.
